(19) United States
(12) Patent Application Publication
(10) Pub. No.: US 2025/0003833 A1
(43) Pub. Date: Jan. 2, 2025

(54) METHOD FOR MONITORING A ROTARY MECHANICAL SYSTEM OF AN AIRCRAFT

(71) Applicants: SAFRAN, Paris (FR); INSAVALOR, Villeurbanne (FR)

(72) Inventors: Yasmine HAWWARI, Moissy-Cramayel (FR); Dany ABBOUD, Moissy-Cramayel (FR); Yosra MARNISSI, Moissy-Cramayel (FR); Mohammed EL BADAOUI, Moissy-Cramayel (FR)

(21) Appl. No.: 18/703,635

(22) PCT Filed: Oct. 24, 2022
(86) PCT No.: PCT/FR2022/052013

§ 371 Date: Apr. 22, 2024

(30) Foreign Application Priority Data
Oct. 27, 2021 (FR) FR2111430

(51) Int. Cl. G01M 13/028; G01H 17/00

(52) U.S. Cl. CPC G01M 13/028; G01H 17/00

(57) ABSTRACT

A method for monitoring a rotary mechanical system of an aircraft including in particular the steps of determining an estimated power spectral density (V) of a noise (v) from a signal (x) representative of vibrations of the rotary mechanical system, determining an equalized power spectral density (Q) by dividing the estimated power spectral density (X) of the signal (x) by the estimated power spectral density (V) of the noise (v), extracting peaks (Q_{det}) from the equalized power spectral density (Q), and identifying a failure in the rotary mechanical system from the extracted peaks.

### TECHNICAL FIELD OF THE INVENTION

The invention relates to the field of the monitoring, by analysing vibration signals, the state of the mechanical systems that make up an aircraft turbomachine. In particular, it relates to a method for monitoring a rotary mechanical system of an aircraft.

### TECHNICAL BACKGROUND

The prior art comprises in particular the documents WO-A1-2010/094915, WO-A1-2014/184657 and the scientific paper entitled “Bayesian extreme value statistics for novelty detection in gas-turbine engines” published in 2008 IEEE Aerospace Conference by David A Clifton et al.

In an aircraft, the rotating mechanical elements generate vibrations which may result from an unbalance, a mass eccentricity, a worn rolling bearings, bent or misaligned shafts, etc., in addition to normal operation.

In this case, the vibrations generated are cyclic in nature, the periodicity of which depends on the element and the type of damage suffered by that element.

For example, an unbalance fault in a rotor generates a purely sinusoidal component whose instantaneous frequency is equal to that of the rotation and whose amplitude is substantially proportional to the square of the speed of rotation.

Another example is the parallel misalignment of a shaft, resulting in the generation of a sinusoidal vibration at twice the frequency of the shaft.

These faults can lead to a reduction in the service life of the mechanical elements concerned, or even to an untimely shutdown of the mechanical system into which the mechanical elements are integrated. In addition, the faults in one mechanical element can affect another mechanical element belonging to the same mechanical system. For example, a misalignment of a shaft leads to a premature wear of the bearings, seals and couplings in the drive train to which this shaft belongs.

The spectral analysis is a well-known technique for analysing the vibration signals. The periodicity of the vibrations results in a signature of said vibrations, which consists of an assembly of peaks in the spectral domain (or Fourrier domain).

Thus, on the basis of a priori knowledge of the kinematics of a monitored mechanical system, an operator can deduce the state of said mechanical system, or even of a single mechanical element of the system, by monitoring the evolution in the amplitude of this signature. However, in practice, a priori knowledge of the mechanical system being monitored is not guaranteed.

Furthermore, in an environment such as an aircraft turbomachine, the blind detection of spectral peaks is complex due to the presence of a high random noise. The vibration signals from the aeronautical mechanical systems are known to have a very low signal-to-noise ratio and to present a coloured noise (as opposed to a white noise).

In most prior art approaches, this noise is often considered to be white Gaussian, which in practice is not the case.

In addition, for rotary aircraft mechanical systems, the frequency structure of the vibration signal spectra is highly complex, making it impossible to know the number of peaks.

### SUMMARY OF THE INVENTION

The present invention proposes a solution to these disadvantages.

To this end, according to a first aspect, the invention relates to a method for monitoring a rotary mechanical system of an aircraft comprising the following steps:
acquiring a signal representative of vibrations in the rotary mechanical system;
determining an estimated power spectral density of said signal;
determining an estimated power spectral density of a noise from the estimated power spectral density of the signal;

said monitoring method being characterised in that it further comprises the following steps:
determining an equalised power spectral density equal to the estimated power spectral density of the signal divided by the estimated power spectral density of the noise;
determining a truncated power spectral density equal to the assembly of the values of the equalised power spectral density below a first threshold;
adjusting the truncated power spectral density by a truncated gamma distribution;
determining, on the basis of the truncated gamma distribution, a second detection threshold;
extracting, from the equalised power spectral density, peaks above the detection threshold; and,
identifying a fault in the rotary mechanical system by comparing the extracted peaks with a reference power spectral density.

The method according to the invention may comprise one or more of the following characteristics, taken alone or in combination with each other:
the vibration representative signal is a vibration signal, preferably obtained from an accelerometer, or an acoustic signal, preferably obtained from a microphone.
the estimated power spectral density of the signal is determined by calculating the averaged periodogram of the signal.
the estimated power spectral density of the noise is determined from a regression applied to the estimated power spectral density of the signal.
the regression is applied to the natural logarithm of the estimated power spectral density of the signal.
the regression function used is a B-spline function.
the first threshold is set so that a given percentage of the values of the equalised power spectral density is retained in the truncated power spectral density.
the adjustment of the truncated power spectral density by a truncated gamma distribution is carried out by maximising a likelihood function of a probability density of said truncated gamma distribution.
the detection threshold is determined such that the probability density of the truncated gamma distribution is equal to a predetermined value referred to as the false alarm probability.
the reference power spectral density corresponds to an equalised power spectral density obtained for a rotary mechanical system of an aircraft turbomachine without failure.

### BRIEF DESCRIPTION OF THE FIGURES

The invention will be better understood and other details, characteristics and advantages of the present invention will become clearer from the following description made by way of non-limiting example and with reference to the attached drawings, in which:

FIG. 1 is a synoptic diagram of the steps in a monitoring method according to one embodiment of the invention;

FIG. 2 is a diagram of the steps in a monitoring method according to one embodiment of the invention;

FIG. 3 is an example of power spectral densities of signals representative of vibrations of a rotary mechanical system according to the invention;

FIG. 4 is an example of equalized power spectral densities of signals representative of vibrations of a rotary mechanical system according to the invention;

FIG. 5 is an example of histograms obtained from the equalised power spectral densities shown in FIG. 4;

FIG. 6 is an example of truncated histograms obtained from the equalised power spectral densities shown in FIG. 4;

FIG. 7 is an example of equalized power spectral densities and detection thresholds according to the invention; and,

FIG. 8 is an example of peaks detected from signals representative of vibrations of a rotary mechanical system according to the invention.

The elements having the same functions in the different embodiments have the same references in the figures.

### DETAILED DESCRIPTION OF THE INVENTION

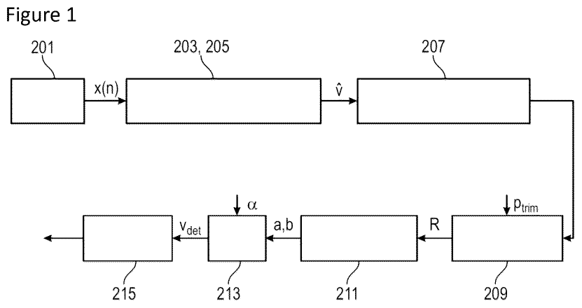

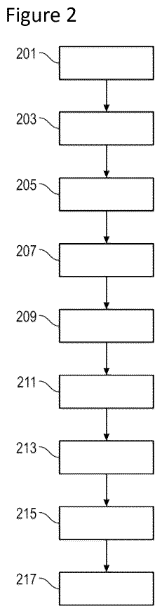

With reference to FIG. 1 and FIG. 2, we will now describe an example of the implementation of a method for monitoring a rotary mechanical system of an aircraft according to the invention.

In the following, a rotary mechanical system is an assembly of rotating mechanical elements that have a single function and are grouped together spatially. For example, an aircraft turbomachine is made up of several rotary mechanical systems, including an auxiliary gearbox (AGB). The various mechanical elements generate vibrations during operation, the frequency and the amplitude of which are affected by any deterioration in their condition.

In the example shown, step 201 consists of acquiring a signal x representative of vibrations of the rotary mechanical system. The signal in question may, in a non-limiting manner, be a vibratory signal, obtained for example from an accelerometer, or an acoustic signal, obtained for example from a microphone.

In addition, it is assumed that the signal x is written in the form:

$$x ( n ) = s ( n ) + v ( n )$$

where n is a sample index, s (n) is a (real) sum of sinusoids characterised by a power spectral density (also referred to by the acronym PSD in the following) with finite spectral masses at discrete frequencies and v (n) is a random stationary broadband component (also real) with variance σᵥ².

For example, in the case of an acoustic signal, s (n) represents the cyclic elements produced by a rotary machine and v (n) represents the effects of the flow noise, turbulence and transient events.

Step 203 consists of determining an estimated power spectral density \hat{X} of the signal x. In the embodiment described, the PSD \hat{X} of the signal x is determined by calculating an averaged periodogram of the signal. It is calculated according to the following equation:

$$\hat{X} ( k ) = \frac{1}{M} {\sum }_{m = 0}^{M - 1} {\vert {\sum }_{n = 0}^{N - 1} w ( n ) x ( n + m H ) {e}^{- \frac{j 2 π kn}{N}} \vert}^{2}$$

where k is a frequency index, H is the overlap size, L is the signal size x, N is the segment size,

$$M = ⌊ \frac{L + H - N}{H} ⌋$$

is the number of available averages and w (n) is the segment size, apodisation window used.

In addition, the person skilled in the art will appreciate that, in alternative implementations of the monitoring method of the invention, step 203 may consist of determining a time transform of the signal x.

Step 205 consists of determining an estimated power spectral density Û of the noise v from the estimated power spectral density X of the signal x.

This step is based on a definition of the PSD of the noise (when x (n)=v (n)) such that:

$$V ( k ) = {lim}_{N \to + ∞} 𝔼 \{ \hat{X} ( k ) \}$$

Insofar as the signal x (n) contains, in addition to v (n), the deterministic part s (n), V is not available but can be estimated from the trend of \hat{X} even if the latter also contains peaks.

So, for example, the PSD \hat{V} of the noise v can be determined from a regression applied to the estimated power spectral density \hat{X} of the signal x. Such an operation is written as follows:

$$\hat{X} ( k ) = f ( k ) + ϵ ( k )$$

where f is a smooth regression function and e is an error.

In the non-limiting example described, insofar as the model of the power spectral density of the noise is unknown (for example when it is referred to as pink noise), the regression is not applied to the PSD \hat{X} globally but rather locally along a sliding window of the PSD \hat{x}.

In other words, the regression function is approximated by a basis of splines and its coefficients are estimated.

These splines are continuous and have continuous derivatives referred to as nodes. The number of nodes determines the bandwidth of the spline, and their conservation properties such as the moments of the data and the absence of edge effects make them relevant for this regression. In addition, the splines have the advantage of simplicity of curvature control and, in particular, the B-spline is numerically stable.

In the example described, the regression function used is a B-spline function. The regression therefore involves first constructing a B-spline base of order o and number of nodes O and then using this base for the regression applied to \hat{X}.

In addition, in the example described, the regression is applied to the natural logarithm of \hat{X} since the use of the natural logarithm allows to homogenise the amplitude of the PSD and to be robust to peaks since the distribution of the natural logarithm of \hat{x} is more symmetrical than that of \hat{X}.

In concrete terms, the regression is written as follows:

$$ln \hat{X} ( k ) = {\sum }_{j = 1}^{O} {B}_{j} {c}_{j} ( k ) + ϵ ( k )$$

where B is the B-spline basis and the coefficients {cⱼ: j=1, . . . , O} are the coefficients of the B-spline.

The distribution of the error ∈(k) makes the regression more robust. The distribution used is a referred to as heavy-tailed distribution to take account of the existence of peaks in the \hat{x}.

In particular, in the example shown, it is a Student's distribution, but the distribution used could be another heavy-tailed distribution. More precisely, the maximum likelihood is calculated from this distribution using the Iteratively reweighted least squares (IRLS) algorithm. This algorithm consists of estimating the error weights by optimising an objective function where the error itself depends on the weighting weights. Given the estimated values {c_{min,j}; j=1, . . . , O}, the estimate of \hat{V} is therefore finally obtained by the following calculation:

$$\hat{V} ( k ) = {e}^{{\sum }_{j = 1}^{o} {B}_{𝔪in , j} {c}_{j} ( k )}$$

In addition, at each iteration of the IRLS algorithm, the samples with an error greater than a specified threshold (in this case, a constant multiplied by the median of the absolute value of the error) can be truncated for greater robustness against peaks.

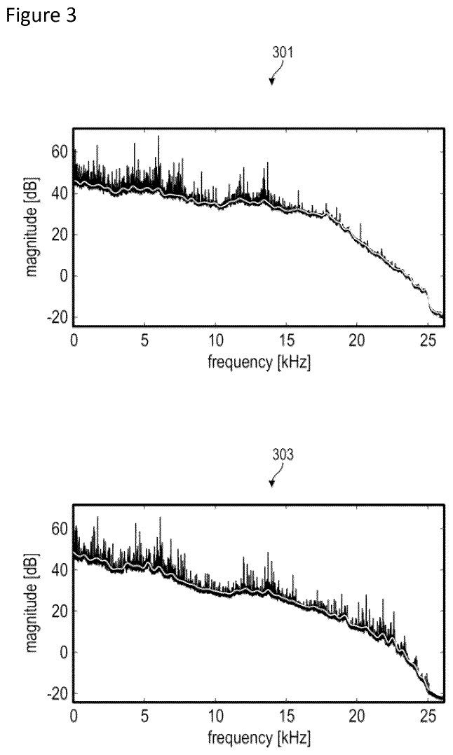

FIG. 3 shows (in black) two examples of estimated power spectral densities \hat{X} of a signal x representing the vibration of the same rotary mechanical system. In the curve 301 the rotary mechanical system is healthy in the sense that it has not suffered any deterioration (compared with its nominal state), whereas in the curve 303 the rotary mechanical system has suffered a deterioration which leads to a change in its vibration behaviour. In addition, the white curves represent the estimated power spectral densities \hat{V} of the noise v obtained from the approach described above.

Step 207 consists in determining an equalised power spectral density Q. This is said to be equalised in that it can be assimilated to a PSD of a white noise. In practice, the Q-equalised PSD is obtained by calculating:

$$Q ( k ) = \hat{X} ( k ) / \hat{V} ( k )$$

The equalisation can be referred to as local frequency in that the way in which the PSD of the noise has been estimated can be likened to a local sliding polynomial regression.

Advantageously, as the PSD equalized Q is comparable to the PSD of a white noise, it is possible to apply to it the statistics designed for a white noise (or for a uniform PSD). For this reason, in the following steps, the various operations are applied to the Q-equalised PSD and not to the estimated PSD \hat{X} of the signal x.

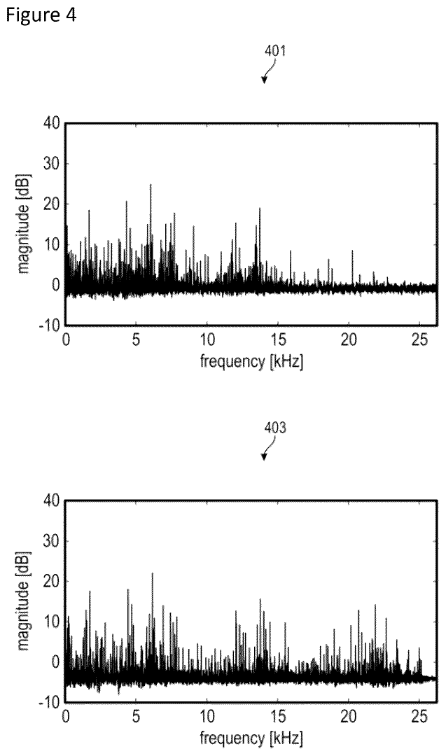

FIG. 4 shows (in black) two examples of Q-equalized power spectral densities obtained from the PSD \hat{X} shown in FIG. 3 by applying the steps described above. The curve 401 corresponds to the healthy rotary mechanical system and the curve 403 corresponds to the damaged rotary mechanical system.

Advantageously, the assembly of the steps described so far allow to obtain the robust neutralisation of a coloured noise, i.e. to avoid its influence on the signal. Furthermore, in this approach, the PSD of the noise is estimated in a way that is robust to the existence of peaks.

Step 209 then consists in determining a truncated power spectral density R which is equal to the assembly of the values of the equalised power spectral density Q which are below a first threshold Qᵣ.

Since Q contains peaks in addition to the spectral noise and only the model of the probability distribution of the spectral noise (which corresponds to the probability distribution of Q(k) if x(n)=v(n)) is known, while the number of peaks and their probability distribution are not known, it is useful to truncate Q to eliminate its highest values in order to retain only what can be considered as spectral noise.

This is so that we can then use a model with a known noise distribution and, consequently, be robust to the peaks.

Thus, R corresponds to R={Q(k)|Q<Qᵣ}, i.e. the assembly of the spectral data below the threshold value Qᵣ.

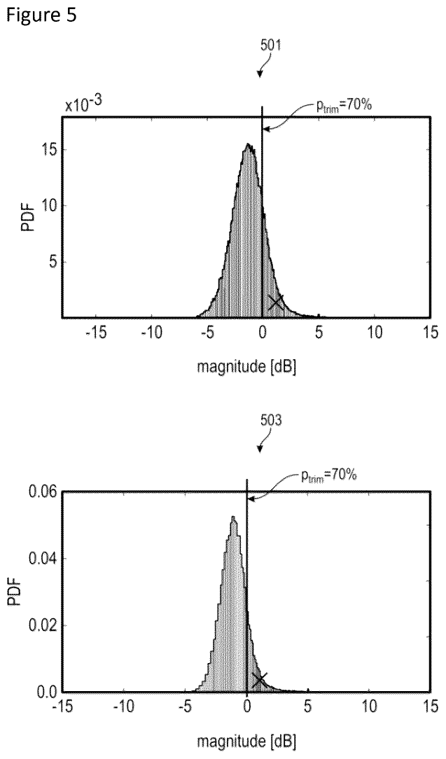

In addition, as shown in FIG. 5, the threshold Qᵣ can be set so that a given percentage Pₜᵣᵢₘ of the values of the equalised power spectral density Q is retained in the truncated power spectral density R. In particular, in the example shown in FIG. 5, the same percentage of 70% is applied to the healthy case 501 and the damaged case 503. Put another way, the top 30% of Q values are eliminated to obtain R.

Step 211 consists of adjusting the truncated power spectral density R by a truncated gamma distribution gᵣ.

The values of Q are assumed to follow a gamma distribution in the case where (n)=v(n)). The values of R are assumed to be distributed according to a right-truncated gamma distribution defined by the equation:

$$∀ u ∈ R {g}_{r} ( u \vert a , b , {Q}_{r} ) = c ( a , b , {Q}_{r} ) g ( u \vert a , b ) ( u < {Q}_{r} )$$

where g(u|a, b)=Γ(a)⁻¹b^{-a}e^{-u/b}u^{a-1}is the full gamma distribution, Γ(.) is the full gamma function and c is the normalisation constant expressed as:

$$c ( a , b , {Q}_{r} ) = \frac{a Γ ( a )}{Γ ( 1 + a ) - Γ ( 1 + a , \frac{{Q}_{r}}{b} ) + {e}^{- \frac{Qr}{b}} {b}^{- a} {Q}_{r}^{a}}$$

where Γ(r, z)=∫_{z}^{∞}e^{-t} t^{r-1} dt is the upper incomplete gamma function.

The constant c can therefore be written as:

$${c ( a , b , {Q}_{r} )}^{- 1} = {\int }_{0}^{{Q}_{r}} g ( t \vert a , b ) dt = P r [ Q ( k ) < {Q}_{r} \vert {H}_{0} ]$$

which corresponds to the probability assigned to the percentile Q of the full gamma distribution. H₀ being the assumption of the spectral noise only (x(n)=v(n)).

The next objective is to infer the value of a and b from the probability density of a right-truncated gamma distribution g, with knowledge of R.

To do this, the approach taken is to find the values of a and b that best allow to adjust the histogram of R, p(R) in the direction of a cost function.

In the example described, this is achieved by using the Kullback-Leibler divergence as a similarity measure. This divergence is defined as follows:

$${D}_{K L} ( p \vert \vert {g}_{r} ) = {\int }_{∞}^{∞} p ( u ) ln \frac{p ( u )}{{g}_{r} ( u \vert a , b , {Q}_{r} )} d u$$

The difference between the logarithms of the probability densities is weighted by p (R). This means considering a high probability where the histogram has a high density of occurrences and, in particular, solving the optimisation problem described by the following equation:

$$( \hat{a} , \hat{b} ) = {argmin}_{a , b} {\int }_{0}^{{Q}_{r}} p ( u ) ln \frac{p ( u )}{{g}_{r} ( u \vert a , b , {Q}_{r} )} d u$$

which can be reduced to:

$$( \hat{a} , \hat{b} ) = {argmin}_{a , b} {\int }_{0}^{{Q}_{r}} p ( u ) ln {g}_{r} ( u \vert a , b , {Q}_{r} ) d u$$

Finally, insofar as Q is distributed as p (R), the cost function can be approximated using the Monte Carlo principle so that it is written as:

$$( \hat{a} , \hat{b} ) = {argmin}_{a , b} {\sum }_{i = 1}^{r} ln {g}_{r} ( Q ( i ) \vert a , b , {Q}_{r} ) \qquad [ Math . 14 ]$$

In the example described, the adjustment of the truncated power spectral density R by a truncated gamma distribution g, is carried out by maximising a likelihood function of a probability density of the truncated gamma distribution gᵣ.

Such a cost function is non-convex and non-differentiable. It can be calculated using the Nelder-Mead algorithm, for example.

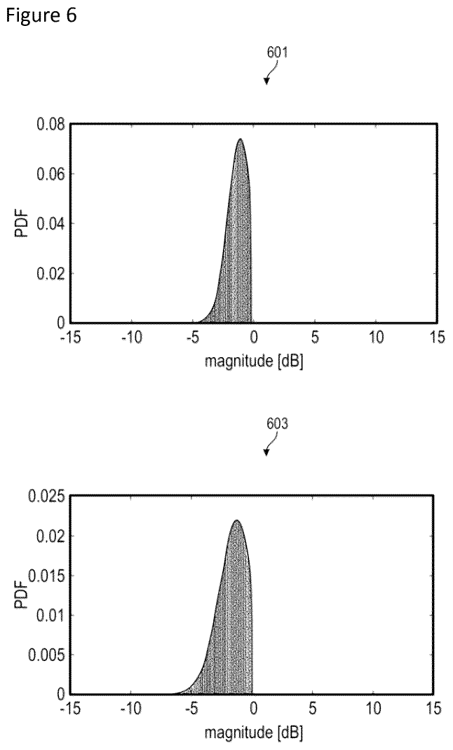

FIG. 6 illustrates (in grey), for the healthy case 601 and for the deteriorated case 603, the histogram of R obtained from Q truncated on the right using the approach described above. In addition, the black curves represent the adjustments of these histograms by probability densities of the right-truncated gamma distribution, also using the approach described above.

Step 213 consists in determining a second detection threshold V_{det} from the truncated gamma distribution gᵣ.

Once the pair of estimated values (â, \hat{b}) has been obtained, the approach followed consists firstly in setting a value known as the false alarm probability a. It represents the probability of detecting a sample as a peak when it is actually noise. It corresponds to a peak detection threshold for which the higher the a value, the greater the number of peaks detected and the greater the risk of detecting spectral noise. a is generally set between 0.01 and 0.001.

The threshold V_{det} is then obtained in agreement with the false alarm probability a from the equation:

$$α = P ( Q \geq {v}_{det} \vert {H}_{0} ) = {\int }_{{v}_{det}}^{∞} g ( t \vert a , b ) dt$$

In this way, the detection threshold V_{det} is independent of the frequency k insofar as the equalisation step has already been performed.

Step 215 consists of extracting, from the equalised power spectral density Q, peaks Q_{det} above the detection threshold V_{det}.

Once V_{det} has been obtained, the statistical detection test is performed to decide which samples are considered peaks, on the basis of strong evidence against the H₀ hypothesis. This is achieved through the following hypothesis test:

$$\{ \begin{matrix}Q ( k ) < {v}_{det} ⇒ {H}_{0} acceptée \\ Q ( k ) \geq {v}_{a e t} ⇒ {H}_{0} rejetée\end{matrix}$$

where hypothesis H₀ corresponds to spectral noise only in \tilde{x}.

The detected samples of Q are therefore the peaks Q_{det}.

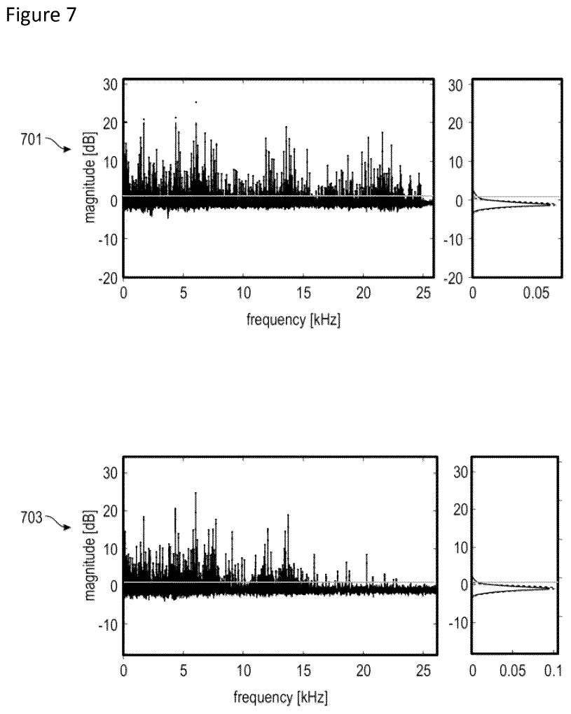

The result of this hypothesis test is illustrated in FIG. 7 for the healthy case 703 and the damaged case 701. The threshold V_{det} is represented as a grey line on either the power spectral densities (left) or the probability densities (right).

Finally, step 217 consists of identifying a fault in the rotary mechanical system by comparing the extracted peaks Q_{det} with a reference power spectral density Q_{ref}.

Since the proposed method allows the mechanical failures to be detected in a blind manner, it is useful to compare the peaks detected in the healthy case with those in the faulty (i.e. deteriorated) case.

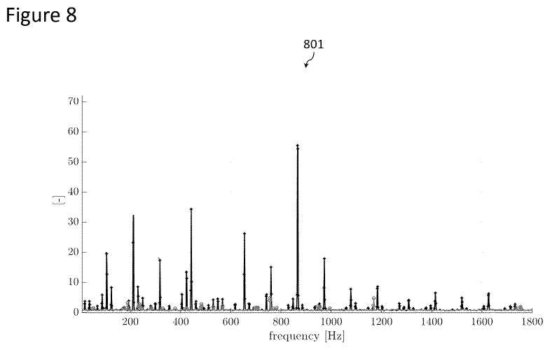

In this case, in the example described, the reference power spectral density Q_{ref} corresponds to an equalised power spectral density obtained for a rotary mechanical system in an aircraft without a fault, and it is the comparison between the two (Q_{det} in black in FIG. 8 and Q_{ref} in grey in FIG. 8) that allows a fault to be identified.

The signals 801 in FIG. 8 illustrate this comparison. The peaks detected in the faulty case Q_{det} (black with “+”) contain new cyclic families that are not present in the assembly of peaks detected in the healthy reference measurement Q_{ref} (grey with “o”).

As a non-limiting example, Q_{ref} can be subtracted from Q_{det} to highlight only anomalies/defects. The energy criterion (i.e. the sum of the squared amplitudes) of the harmonics detected in this assembly can then be used as an indicator of the presence of one or more faults.

Advantageously, this allows, even without knowing the kinematics of the system, to detect an anomaly and, if necessary, trigger a fault alarm insofar as a whole family of harmonics characterised by a repetition (harmonics) and a modulation (sidebands).

Advantageously, the monitoring method according to the invention is blind, i.e. it does not require any a priori knowledge of the rotary mechanical system being monitored (i.e. its kinematics).

Advantageously also, the monitoring method described is robust to the use of a signal with an unknown PSD with coloured noise.

Advantageously, the detection threshold obtained is independent of the frequency.

In addition, the monitoring method according the method means that not all peaks can be monitored, but only frequencies of interest can be targeted.

In addition, the monitoring is based on the appearance of an assembly of frequencies, unlike conventional approaches which consider the amplitude and sometimes the phase.

Finally, the monitoring method according to the invention is also robust to the application to a rotary mechanical system in which the number of mechanical elements that generate vibrations is unknown.

1. A method for monitoring a rotary mechanical system of an aircraft, comprising the following steps:
acquiring a signal representative of vibrations of the rotary mechanical system;
determining an estimated power spectral density (\hat{X}) of said signal (x);
determining an estimated power spectral density (\hat{V}) of a noise (v) from the estimated power spectral density (\hat{X}) of the signal (x);
wherein said monitoring method further comprises the following steps:
determining an equalised power spectral density (Q) equal to the estimated power spectral density (\hat{x}) of the signal (x) divided by the estimated power spectral density (\hat{V}) of the noise (v);
determining a truncated power spectral density (R) equal to the assembly of the values of the equalised power spectral density (Q) below a first threshold (Qᵣ);
adjusting the truncated power spectral density (R) by a truncated gamma distribution (gᵣ);
determining, on the basis of the truncated gamma distribution (gᵣ), a second detection threshold (V_{det});
extracting, from the equalised power spectral density (Q), peaks (Q_{det}) above the detection threshold (V_{det}); and,
identifying a fault in the rotary mechanical system from a comparison of the extracted peaks (Q_{det}) with a reference power spectral density (Q_{ref}).

2. The method according to claim 1, wherein the vibration representative signal (x) is a vibration signal, preferably obtained from an accelerometer, or an acoustic signal, preferably obtained from a microphone.

3. The method according to claim 2, wherein the estimated power spectral density (\hat{X}) of the signal (x) is determined from the calculation of the averaged periodogram of the signal (x).

4. The method according to claim 1, wherein the estimated power spectral density (\hat{V}) of the noise (v) is determined from a regression applied to the estimated power spectral density (\hat{X}) of the signal (x).

5. The method according to claim 4, wherein the regression is applied to the natural logarithm of the estimated power spectral density (\hat{X}) of the signal (x).

6. The method according to claim 4, wherein the regression function used is a B-spline type function.

7. The method according to claim 1, wherein the first threshold (Qᵣ) is set so that a determined percentage (Pₜᵣᵢₘ) of the values of the equalised power spectral density (Q) is retained in the truncated power spectral density (R).

8. The method according to claim 1, wherein the adjustment of the truncated power spectral density (R) by a truncated gamma distribution (gᵣ) is carried out on the basis of a maximisation of a likelihood function of a probability density of said truncated gamma distribution (gᵣ).

9. The method according to claim 1, wherein the detection threshold (V_{det}) is determined such that the probability density of the truncated gamma distribution (gᵣ) is equal to a predetermined value (a) referred to as the false alarm probability.

10. The method according to claim 1, wherein the reference power spectral density (Q_{ref}) corresponds to an equalised power spectral density obtained for a rotary mechanical system of a fault-free aircraft.
